(19) United States
(12) Patent Application Publication
(10) Pub. No.: US 2019/0385341 A1
(43) Pub. Date: Dec. 19, 2019

(54) DYNAMIC VISUAL AND AUDIO GEOTAGGED PHOTO FILTER

(71) Applicant: Life Impact Solutions, LLC, Irvine, CA (US)

(72) Inventor: Aaron Horvath, Ladera Ranch, CA (US)

(21) Appl. No.: 16/443,748

(22) Filed: Jun. 17, 2019

Related U.S. Application Data
(60) Provisional application No. 62/685,812, filed on Jun. 15, 2018.

(51) Int. Cl. G06T 11/00; G06F 16/487

(52) U.S. Cl. CPC G06T 11/00; G06F 16/487

(57) ABSTRACT

The present invention provides methods and systems of logically linking audio and/or visual elements to create geolocation-based messages. An AV engine operating on a cell phone or other mobile device, uses location information of the device to download at least one of a visual element and an audio element, logically link the downloaded element(s) with an image, and distribute the downloaded element(s) and the image to social media recipients, such that the downloaded element(s) is/are rendered along with the image, when the image is viewed by a recipient. The linked image is preferably an image taken by the device. The downloaded visual and/or audio elements can advantageously be logically linked with at least one of altitude information, time information, one or more use cases, an occurrence or a non-occurrence of an event.

This application claims the benefit of U.S. provisional application No. 62/685,812, filed Jun. 15, 2018. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is media sharing applications.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

It is known to display within a photo placemakers in a geographic information system, as taught by U.S. Pat. No. 9,280,258 to Bailly. However, Bailly fails to contemplate the inclusion of both audio and visual elements in the photo placemakers. Further, Bailly also fails to disclose the use of social media groups and providing audio and visual elements based on non-geographic coordinate based parameters (e.g., altitude, time, use cases, etc.).

It is also known to provide graphic frame content that is automatically customized based on the geographic location of a mobile device, as taught by US 2014/0205196 to Freedman. However, the graphic frame content is purely visual and fails to contemplate the inclusion of audio elements in the graphic game.

Thus, there remains a need for a system and method that filters photos in more than just a visual manner.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter contemplates practical uses of geolocation information, including personalizing and managing dissemination of social media messaging, by adding pre-recorded and/or custom generated sounds and visuals to the messaging.

In some embodiments, the inventive subject matter contemplates limiting customized audio and video elements to members of various groups, to increase the relevance and impact of the messaging from those members. For example, a contemplated embodiment could allow a veteran to add a personal motivational message and custom photo filter that unlocks only when he or she takes a photo near a war memorial. That special filter could significantly personalize the message, and thereby increase a feeling of belonging to a military or other interested group.

Various objects, features, aspects and advantages of the inventive subject matter will become more apparent from the following detailed description of preferred embodiments, along with the accompanying drawing figures in which like numerals represent like components.

The inventive subject matter provides apparatus, systems, and methods in which both visual and audio elements are added to an image created by a device. Such systems can be incorporated into systems described in co-pending application Ser. No. 14/804075 or 15/399541, which are both incorporated herein by reference.

### DETAILED DESCRIPTION

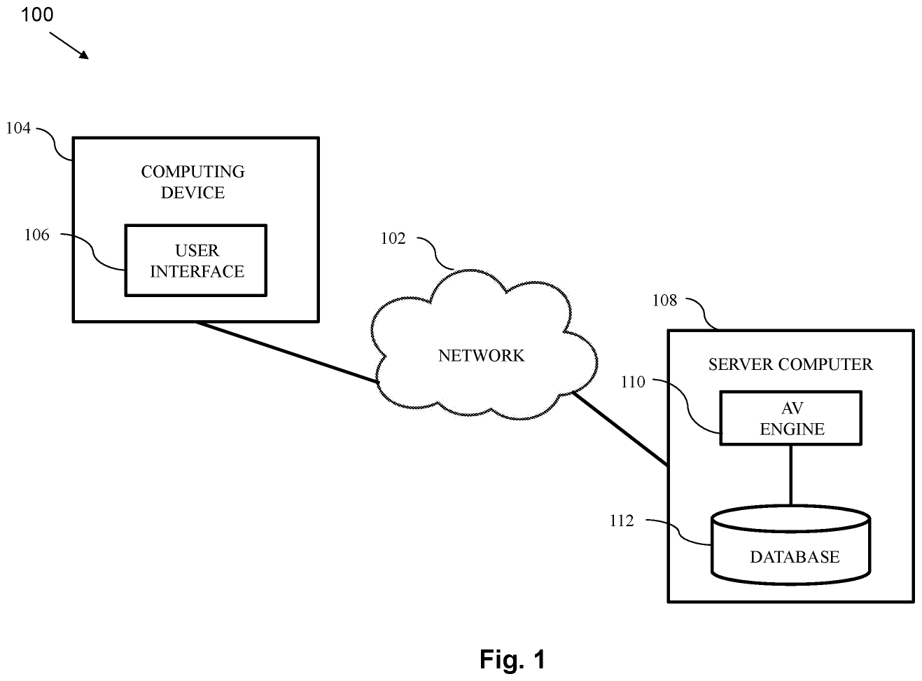

FIG. 1 is a functional block diagram illustrating a distributed data processing environment for providing geotagged visual and audio photo filters.

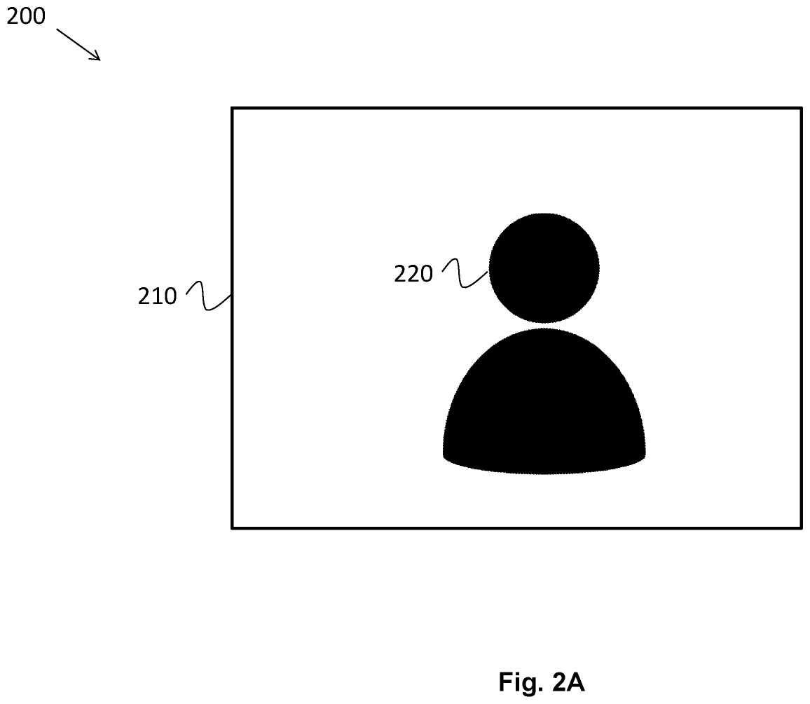

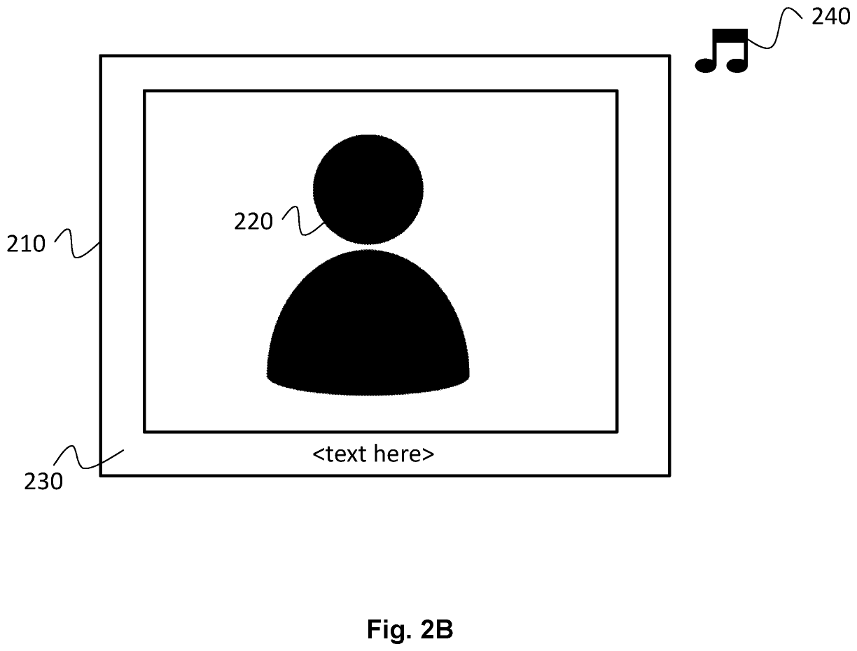

FIGS. 2A and 2B show an example of providing geotagged visual and audio filters to an existing photo.

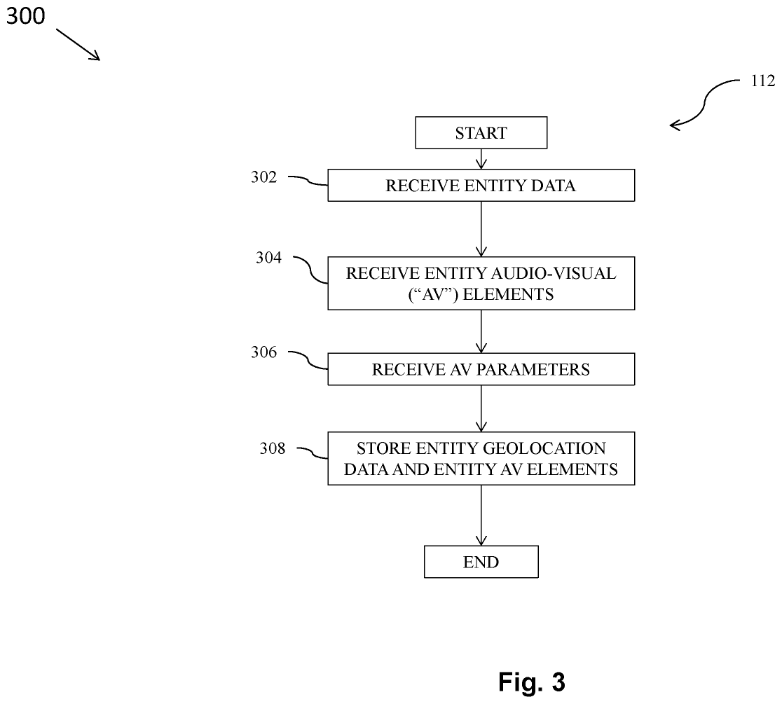

FIG. 3 is a schematic of a method of registering businesses with AV engine 110.

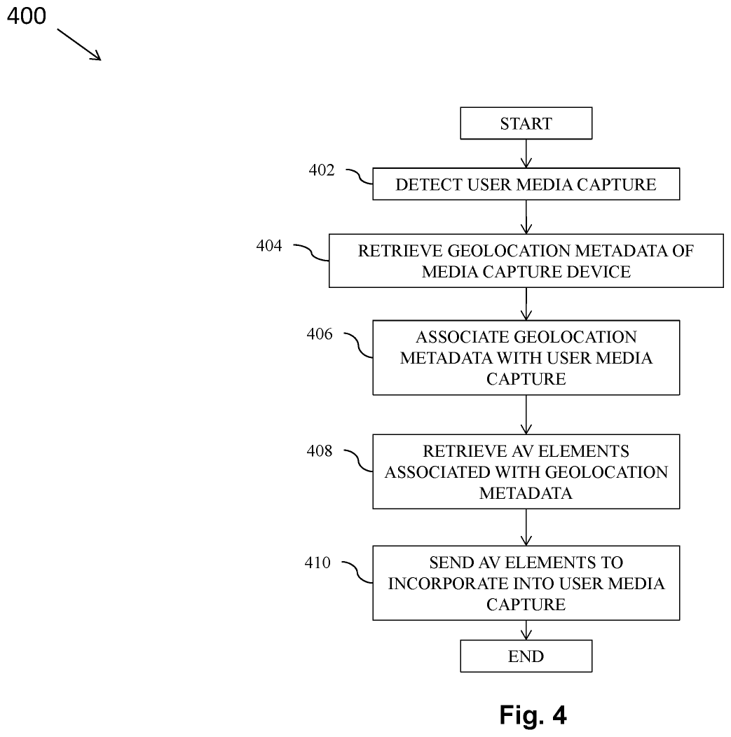

FIG. 4 is a schematic of a method of delivering AV elements relevant to a social media post using the geolocation metadata of a media capture image.

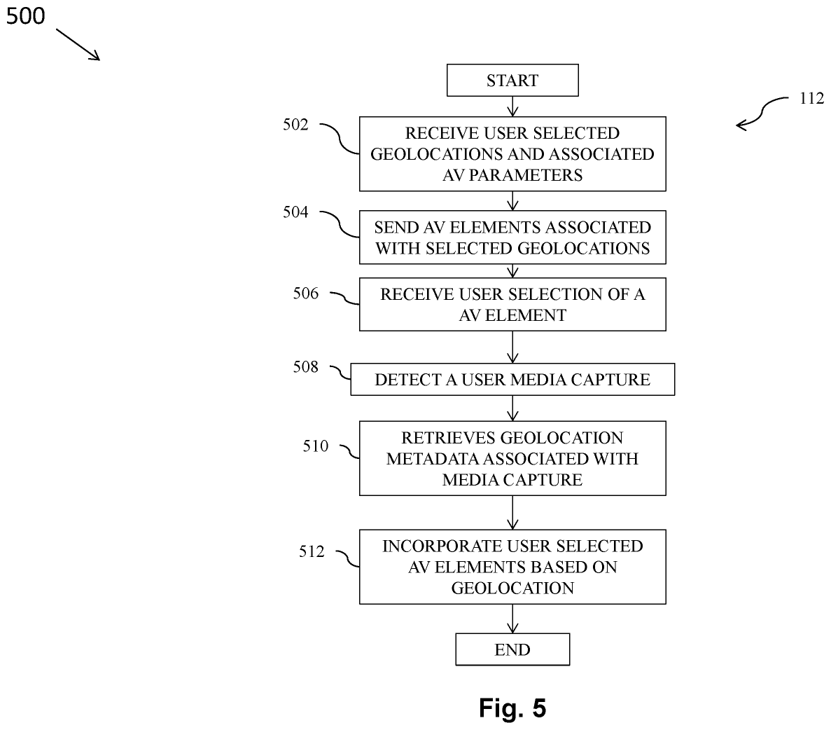

FIG. 5 is a schematic of a method of applying user preselected AV elements when a user enters a particular geolocation.

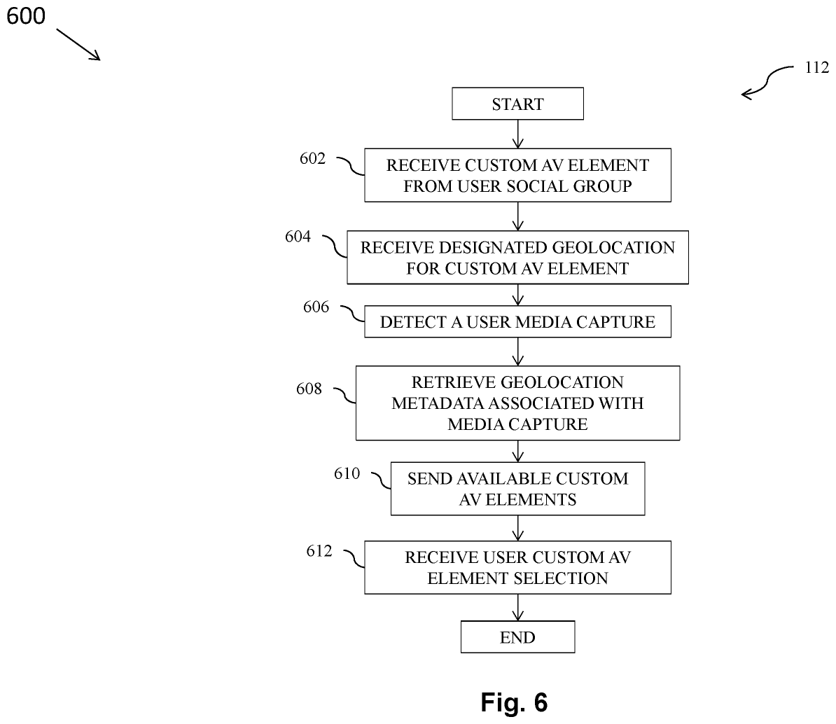

FIG. 6 depicts is a schematic of a method of applying custom AV elements designated by a user's social group when a user enters a particular geolocation.

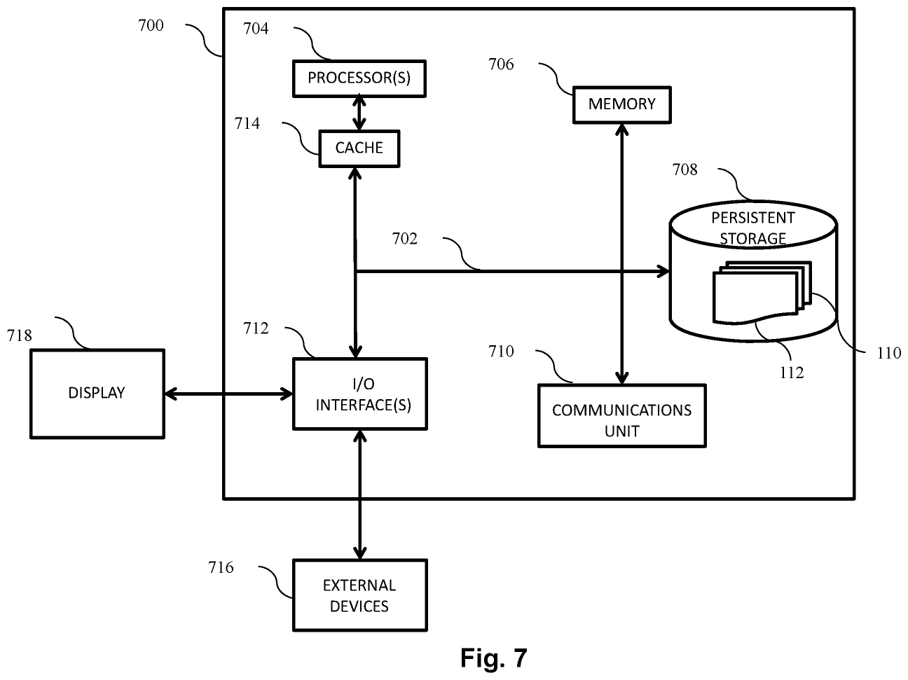

FIG. 7 depicts a block diagram of components of the server computer executing AV engine 110 within the distributed data processing environment of FIG. 1.

### DETAILED DESCRIPTION

FIG. 1 is a functional block diagram illustrating a distributed data processing environment for providing geotagged visual and audio photo filters.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104, server computer 108, and any other computing devices (not shown) within distributed data processing environment 100.

Computing device 104 can be a cell phone, laptop, tablet, wearable computing devices, or any other programmable electronic computing device capable of communicating with various components and devices within distributed data processing environment 100, via network 102. It is further contemplated that computing device 104 can execute machine readable program instructions and communicate with any devices capable of communication wirelessly and/or through a wired connection. Computing device 104 includes an instance of user interface 106.

Computing device 104 is preferably a cell phone having a geographical location identifier, such as a GPS system, and an image-creation system, such as a camera. Contemplated devices include mobile telephone systems.

User interface 106 provides an interface to AV engine 110. Preferably, user interface 106 comprises a graphical user interface (GUI) or a web user interface (WUI) that can display one or more of text, documents, web browser windows, user option, application interfaces, and operational instructions. It is also contemplated that user interface can display or otherwise render any suitable information, including for example, graphics, texts, and sounds that a program presents to a user, and the control sequences that allow a user to control a program.

In some embodiments, user interface can be mobile application software. Mobile application software, or an “app,” is a computer program designed to run on smart phones, tablet computers, and any other mobile devices.

User interface 106 can allow a user to register with and configure AV engine 110 (discussed in more detail below), to enable a user to use AV engine 110 in a social media system. Among other things, user interface 106 can allow a user to provide any information to audio-visual engine 110 (hereinafter, “AV engine 110”).

Server computer 108 can be a standalone computing device, a management server, a web server, a mobile computing device, or any other computing system capable of receiving, sending, and processing data.

Server computer 108 can include any suitable server computing system, including clustered computers and components that act as a single pool of seamless resources when accessed within distributed data processing environment 100.

Database 112 is a repository for data used by AV engine 110. In the depicted embodiment, AV engine 110 resides on server computer 108. However, database 112 can reside anywhere within a distributed data processing environment provided that AV engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

Database 112 saves various visual and audio elements that are associated with geographic locations. For example, visual filters that can be applied to an image, or audio clips that can be applied to an image. In some embodiments, the visual elements are tied to the audio elements, for example a photo frame featuring a brand of a company, and an audio jingle of the company, while in other embodiments the visual elements are not associated with the audio elements. In some embodiments the visual and audio filters could be applied to a video, or a segment of a video, saved on the device.

As used herein, an “image” is a static digital image that is saved on a memory of a computer system, such as computing device 104.

As used here “associated” and any derivatives thereof includes, but is not limited to, logically linked entities. Logically linked entities can be directly connected and/or indirectly connected to each other.

FIGS. 2A and 2B show an example of providing geotagged visual and audio filters to an existing photo.

In FIG. 2A, an image 210 is taken having an inherent visual element 220 that is generated by the image-creation device. In FIG. 2B, the application installed on the device provides visual element 230 and audio element 240 which can be superimposed on image 210 to add geolocated elements to the image.

The application can merge the visual and/or audio elements 230 and 240. In another embodiment, the application can associated a separate file with the original media for cooperative playback when a user accesses the image 210. For example, Pages™ files stored on Apple® products utilize separate files for content and format.

Preferably, the application sends the location to the database, which then returns visual/audio elements associated with the geolocation to the device. In some embodiments, a portion of the database could be loaded on the device itself, which can then perform a local search for the visual/audio elements.

In some embodiments, the image could also be associated with an audio clip captured by an audio-capturing element of the device, such as a microphone, allowing a user to create an image with a superimposed geotagged visual element, with an associated user-created audio clip with a superimposed geotagged audio element.

In some embodiments, the user could associate several geotagged visual elements and/or geotagged audio elements with the same image. In some embodiments, the device could create a video having several superimposed geotagged visual and audio elements interspersed throughout the clip.

FIG. 3 is a schematic of a method of registering businesses with AV engine 110.

AV engine 110 receives entity data (step 302).

AV engine 110 enables an entity, including for example, a business organization or a service provider, to reach customers by proxy of social media users. It is contemplated that AV engine 110 works cooperatively with social media content editing software (e.g., social media-integrated photo editing software) to enable composite media to be incorporated into a user's social media posts.

As used herein, entity data comprises any information associated with an entity. In a preferred embodiment, entity data comprises one or more geolocations associated with an entity, one or more time frames, and at least one AV element for incorporation into social media posts. For example, a local guitar store can submit the name and address of the business, the geolocation of the guitar store, the geolocation of a local concert venue, and a time frame of Friday-Saturday between the hours of 4:00 PM to 12:00 AM. It is contemplated that entity data allows AV engine 110 to offer particular AV elements to social media users based on one or more parameters.

The preceding embodiments and examples are merely illustrative, and entities can include any number of composing parameters in entity data. For example, entities can apply a unique set of composing parameters (e.g., time, date, proximity threshold) for each geolocation listed in the entity data. In another example, entities can apply a unique set of composing parameters to particular AV elements.

AV engine 110 receives an AV element from the entity (step 304).

AV elements can include any expression representing the entity, including, for example, sounds, tactile expressions, visuals, and any other sensory expressions. It is contemplated that the entity, in some embodiments, can pay to sponsor AV elements for specific locations, dates, and times. In other embodiments, the entity can send AV engine 110 one or more AV elements for free. Further, AV elements can be pre-stored or specific to a geographic location.

In a first embodiment, AV elements comprise audio clips, videos, augmented-reality based overlays, and images.

Audio clips can include any playable sound-based media. For example, audio clips can be sound bites from a popular television sitcom when near the show's filming studio. In another example, audio clips can be humorous commercial jingles associated with a popular restaurant chain. In yet another example, audio clips can be slogans promoting sustainability that is associated with an environmental conservation organization.

Videos can include any series of images played in sequence. It is further contemplated that, in some embodiments, the videos can be accompanied by corresponding audio clips.

For example, videos can be cartoons that can be included in a social media message. In another example, videos can be advertising clips that are incorporated into social media posts.

The augmented reality overlays can include, but are not limited to, logos, words, videos, and graphics interchange format (GIF) videos. In one embodiment, an augmented reality overlay can utilize one or more facial and/or object recognition technologies associated with computing device 104. It is contemplated that computing device 104 can comprise any technologies associated with augmented reality technology, such as recognition software, depth sensing cameras, and infrared cameras.

AV engine 110 receives composing parameters from the entity (step 306).

Composing parameters include any rules that can be applied to AV elements. For example, where a local store submits images, videos, and audio clips that advertise particular sales, each AV element can have a particular set of dates and times of day that the AV can be incorporated into a social media post. In another example, composing parameters can include restrictions based on age for context images associated with particular businesses or products (e.g., restricting social media users registered under the age of 21 from context images associated with alcoholic products). It is contemplated that entity data allows AV engine 110 to offer particular AV elements to social media users based on any one or more parameters.

AV engine 110 stores the geolocation data and the AV elements from the entity in database 112 (step 308).

It is contemplated that AV engine 110 stores the geolocation location data, AV elements, and any parameters associated with the geolocation data and the AV elements in database 112.

FIG. 4 is a schematic of a method of delivering AV elements relevant to a social media post using the geolocation metadata of a media capture image.

AV engine 110 detects a media image captured by a user (step 402).

A user media capture image can include any media captured data associated with any sensor. Sensors can include, but are not limited to, cameras, microphones, accelerometers, and depth sensors. For example, AV engine 110 can detect that a user recorded a video using a camera and a microphone.

In another example, AV engine 110 can detect that a user recorded a video that includes depth data, which can be used to include context images in an augmented reality-based environment. For example, if the user recorded a video with depth data at a concert, AV engine 110 could include a context image comprising the bands logo and the location of the concert imposed above the band playing onstage.

In yet another example, AV engine 110 can detect the movements associated with an accelerometer during a video capture to allow the context images included the video to be “knocked around” realistically with accompanying camera shake and sound effects.

AV engine 110 retrieves geolocation metadata of the user media capture device (step 404).

Geolocation metadata can include, but is not limited to, using an exchangeable image file format (EXIF) associated with a photo.

It is contemplated that AV engine 110 can work cooperatively with a global position system (GPS) on the media capture device to record data, including, for example, a date, a time of day, a direction (e.g. north, south, east, west, etc.), and geographic coordinates. However, geolocation metadata can include any details associated with the circumstances of the media capture.

AV engine 110 associates the geolocation metadata with the user media capture (step 406).

AV engine 110 ties the geolocation metadata to a particular media capture. In some embodiments, AV engine 110 can tie the geolocation metadata to a set of media captures. For example, AV engine 110 can detect and record a set of media captures within one mile of each other and tie a common geolocation metadata to all of the media captures.

AV engine 110 detects a user-initiated social media action associated with the user media capture (step 408).

A user initiated social media action can be any action associated with a social network. For example, user social media actions can include, but are not limited to, opening a social media program, inputting any one or more commands associated with a social media program, uploading a media file, retrieving a media file, and capturing media.

In a preferred embodiment, AV engine 110 detects a user-initiated social media action that is initiated at a different time and location than the original time and location of the user media capture. For example, AV engine 110 can detect that a user is attempting to post a photo that was taken a week earlier. Based on the geolocation metadata of the user media capture, AV engine 110 can retrieve AV elements associated with the time, location, and any other parameters associated with the geolocation metadata.

In a more specific example, AV engine 110 can detect that a user is taking the steps to post a video of an event a week earlier. Based on the geolocation data associated with the photo, AV engine 110 can send a series of event-specific logos, filters, and audio clips that are no longer available at the time of the social media post.

AV engine 110 retrieves one or more AV elements associated with the geolocation metadata of the user media capture (step 410).

As discussed above, AV elements can be tied to any one or more composing parameters. In a preferred example, AV elements are offered for inclusion into a user's social media post based on whether a social media user falls inside or outside of a boundary defining a geofence associated with each AV element.

Importantly and as discussed in detail above, AV engine 110 can retrieve AV elements particular to the geolocation metadata of the user media capture. AV engine 110 advantageously allows users to delay posting their photos without losing out on the particular AV elements that were available during that time and location. As such, AV engine 110 streamlines the social media process by enabling users to avoid taking frequent breaks to post on social media in order to take advantage of time-sensitive and location-sensitive AV elements.

By retrieving AV elements based on the geolocation metadata of a photo, AV engine 110 advantageously allows users to create archives of photos with context-specific additions at a later time, on their own schedule.

AV engine 110 sends the AV elements to the user for incorporation into a social media post (step 412).

It is contemplated that AV engine 110 can additionally track the sharing of AV elements to determine the reach of an entity's AV elements. It is further contemplated that an entity can either receive the tracked sharing of the entity's AV elements for a fee or for free.

AV engine 110 sends the AV elements through any medium associated with network 102. In a preferred embodiment, AV engine 110 sends AV elements to a user's device via a cellular data network. For example, AV engine 110 can send one or more entity logos to a smartphone over a 5G cellular data network.

In another embodiment, AV engine 110 can send AV elements to a smartphone over a wireless fidelity (WiFi) network. In embodiments where AV engine 110 and database 112 reside on computing device 104, AV engine 110 can send AV elements to a smartphone via hardwired connections.

FIG. 5 is a schematic of a method of applying user preselected AV elements when a user enters a particular geolocation.

AV engine 110 receives one or more geolocations selected by a user (step 502).

In a preferred embodiment, AV engine 110 receives one or more user selections of geolocations associated with time and date-based parameters. For example, AV engine 110 can receive a first geolocation and a second geolocation and the time and date the user anticipates being at each geolocation.

In a more specific example, AV engine 110 can receive a selection of a concert venue and a food venue and a time designation of 500 PM-7:00 PM and 8:00 PM-10:00 PM, respectively. Based on the user-selected geolocations and associated parameters, AV engine 110 can anticipate the relevant AV elements attach to a user's social media post. For example, AV engine 110 can queue a list of five AV elements associated with the concert venue that are authorized by the concert venue to be added to social media posts at the designated time.

AV engine 110 sends AV elements available for one or more geolocations selected by a user (step 504).

In preferred embodiments, AV engine 110 sends AV elements that are stored in database 112 for the user-submitted time, date, and location. For example, AV engine 110 can send one or AV elements for a user to select and place on a sample user media capture to create a template for a future event. In this example, it is contemplated that the user is restricted from posting any content with the future AV elements until the user captures media that has geolocation metadata that falls within the location and composing parameters.

AV engine 110 receives a user selection of AV elements for one or more geolocations (step 506).

It is contemplated that a user can set different template incorporating one or more AV elements.

It is further contemplated that the user can also submit parameters for inclusion of AV elements in the same event based on one or more variables. For example, AV engine 110 can receive a user selection of a band logo for an opening act in a concert on any social media posts from 7:00 PM-8:30 PM and a different band logo for a headlining band from 8:30 PM-10:00 PM when the headliner is slotted to play.

AV engine 110 detects a user media capture (step 508).

A user media capture can include any media capture associated with any sensor. Sensors can include, but are not limited to, cameras, microphones, accelerometers, and depth sensors. For example, AV engine 110 can detect that a user recorded a video using a camera and a microphone.

In another example, AV engine 110 can detect that a user recorded a video that include depth data, which can be used to include AV elements in an augmented reality-based environment.

In yet another example, AV engine 110 can detect the movements associated with an accelerometer during a video capture to allow graphical AV elements included in the video to be “knocked around” realistically with corresponding camera shake and playback of audio AV elements.

AV engine 110 retrieves geolocation metadata associated with the media capture (step 510).

It is contemplated that AV engine 110 can work cooperatively with a global position system (GPS) on the media capture device to record data, including, for example, a date, a time of day, a direction (e.g. north, south, east, west, etc.), and geographic coordinates. However, geolocation metadata can include any details associated with the circumstances of the media capture.

AV engine 110 incorporates a user selected AV element with the media capture based on geolocation metadata (step 512).

FIG. 6 depicts is a schematic of a method of applying custom AV elements designated by a user's social group when a user enters a particular geolocation.

AV engine 110 receives a custom AV element from user social group (step 602).

Custom AV elements are any AV elements that have been personally curated by a user. Custom AV elements can comprise user-made elements and/or a third-party elements. User-made elements, for example, can be a sketch drawn through a user's smartphone that is translated to a custom AV element.

Third-party elements, for example, can be graphic art provided by a company to promote its brand. It is contemplated that third-party elements can be arranged and manipulated by users to create custom AV elements. For example, third-party elements can allow a user named “Kelly” to input her name into a promotional graphic of a cup with the name “Kelly” digitally written on the cup.

In one embodiment, the third party element is software to manipulate one or more sounds and/or graphics. For example, a third party element can change the recorded voice of a user to a popular cartoon character associated with a sponsored product.

In another embodiment, the third party element combines software and user-provided elements. For example, a software-based voice changer can analyze the vocal characteristics of a first user in a closed social group and allow the first user to create an AV element that changes a second user's voice into the voice of the first user. In another example, an image manipulation software can receive input from a first user instructing the software to manipulate user facial features in a particular way (e.g., big eyes and tiny mouths) and apply that image manipulation to an image of a second user's face.

AV engine 110 receives use parameters for the custom AV element (step 604).

The use parameters can include any means of controlling the use of the custom AV element. For example, the use parameters can be based on location, social networks, time, date, and user-specific characteristics (e.g., gender). It is also contemplated that the user parameters can include no parameters at all. For example, a user creating a custom AV element can make use of the custom AV element subject to no conditions.

It is further contemplated that use parameters and any other types of parameters disclosed herein can employ any one or more sensors (e.g., pressure, light, image, sound, etc.) in creating and using an AV element.

It is also contemplated that the posting of custom AV elements can be subject to particular parameters. For example, a custom AV element can be restricted to AV elements created by social media group members while in a particular geolocation.

In a location-based example, a posting member of a social media group can upload a custom filter that they created using their own art regarding an inside joke specific to the group. The posting member can set the use parameters to restrict the use of the custom filter to the geographical bounds of a particular university dormitory.

In an altitude-based example, a posting member of a social media group can upload a motivation recording of the posting member's voice along with a motivational note (e.g., “Congrats on reaching 1000 ft!”) that activates at a particular altitude during a fellow member's hike. It is contemplated that the note and audio recording can be included in a social media post posted by the fellow member.

In a use-case example, a posting member of a social media group can upload a filter with a custom celebratory banner for a first team of two teams in a final championship and set a use case to activate the custom celebratory banner if the first team wins the final championship.

In a time-based example, a posting member of a social media group can upload an custom audio recording wishing everyone else in the social media group a happy New Year's that activates at midnight of December 31^{st} and deactivates at midnight of January 1^{st}.

AV engine 110 detects a user media capture (step 606).

AV engine 110 retrieves the geolocation metadata associated with the user media capture (step 608).

AV engine 110 sends available custom AV elements to the user based on the geolocation metadata (step 610).

AV engine 110 sends the AV elements through any medium associated with network 102. In a preferred embodiment, AV engine 110 sends AV elements to a user's device via a cellular data network. For example, AV engine 110 can send one or more entity logos to a smartphone over a 5G cellular data network.

In another embodiment, AV engine 110 can send AV elements to a smartphone over a wireless fidelity (WiFi) network. In embodiments where AV engine 110 and database 112 reside on computing device 104, AV engine 110 can send AV elements to a smartphone via hardwired connections.

AV engine 110 receives user selection of one or more custom AV elements (step 612).

FIG. 7 depicts a block diagram of components of the server computer executing AV engine 110 within the distributed data processing environment of FIG. 1.

FIG. 7 is not limited to the depicted embodiment. Any modification known in the art can be made to the depicted embodiment.

In one embodiment, the computer includes processor(s) 704, cache 714, memory 706, persistent storage 708, communications unit 710, input/output (I/O) interface(s) 712, and communications fabric 702.

Communications fabric 702 provides a communication medium between cache 714, memory 706, persistent storage 708, communications unit 710, and I/O interface 712. Communications fabric 702 can include any means of moving data and/or control information between computer processors, system memory, peripheral devices, and any other hardware components.

Memory 706 and persistent storage 708 are computer readable storage media. As depicted, memory 706 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 706 and persistent storage 708 are random access memory and a hard drive hardwired to computing device 104, respectively. For example, computing device 104 can be a computer executing the program instructions of AV engine 110 communicatively coupled to a solid state drive and DRAM.

In some embodiments, persistent storage 708 is removable. For example, persistent storage 708 can be a thumb drive or a card with embedded integrated circuits.

Communications unit 710 provides a medium for communicating with other data processing systems or devices, including data resources used by computing device 104. For example, communications unit 710 can comprise multiple network interface cards. In another example, communications unit 710 can comprise physical and/or wireless communication links.

It is contemplated that AV engine 110, database 112, and any other programs can be downloaded to persistent storage 708 using communications unit 710.

In a preferred embodiment, communications unit 710 comprises a global positioning satellite (GPS) device, a cellular data network communications device, and short to intermediate distance communications device (e.g., Bluetooth ®, near-field communications, etc.). It is contemplated that communications unit 710 allows computing device 104 to communicate with other computing devices 104 associated with other users.

Display 718 is contemplated to provide a mechanism to display information from AV engine 110 through computing device 104. In preferred embodiments, display 718 can have additional functionalities. For example, display 718 can be a pressure-based touch screen or a capacitive touch screen.

In yet other embodiments, display 718 can be any combination of sensory output devices, such as, for example, a speaker that communicates information to a user and/or a vibration/haptic feedback mechanism. For example, display 718 can be a combination of a smart phone touch screen, a voice command-based communication system, and a vibrating bracelet worn by a user to communicate information through a series of vibrations.

It is contemplated that display 718 does not need to be physically hardwired components and can, instead, be a collection of different devices that cooperatively communicate information to a user.

The above discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Computer software that is “programmed” with instructions is developed, compiled, and saved to a computer-readable non-transitory medium specifically to accomplish the tasks and functions set forth by the disclosure when executed by a computer processor. In the context of computing, the term “functionally coupled to” refers to electronic devices that are electronically (wired or wirelessly) coupled with one another to transfer electronic signals/data from one device to another.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system, comprising:
a database configured to logically link visual and audio elements with geographic information;
an application installed on a device having an image-creating device, and a geographic location identifier, the application configuring the device to:
receive an image from the image-creating device;
receive a current location from the geographic location identifier;
receive from the database an audio element associated with the geographic location identifier; and
logically link the image with the audio element on a computer-readable memory, such that when the image is selected by at least one recipient of the image, the audio element is rendered with the image.

2. The system of claim 1, wherein the audio element is logically linked with altitude information.

3. The system of claim 1, wherein the audio element is logically linked with time information.

4. The system of claim 1, wherein the audio element is logically linked with one or more use cases.

5. The system of claim 4, wherein the one or more use cases are based on an occurrence of an event.

6. The system of claim 4, wherein the one or more use cases are based on a non-occurrence of an event.

7. The system of claim 1, wherein the application is further programmed to retrieve a list of potential recipients in a social media group that is logically linked with a user of the device.

8. The system of claim 7, wherein the application is further programmed to send the audio element to the social media group.

9. The system of claim 1, wherein the audio element is manipulated using input from one or more sensors of the device.

10. The system of claim 1, wherein the application further configures the device to receive a visual element associated with the geographic location identifier, and logically link the image with the visual element.

11. A method of incorporating audio elements into social media posts, comprising:
receiving an image from an image-creating device;
receiving a current location from a geographic location identifier;
receiving from a database a audio element logically linked with the geographic location identifier; and
logically linking the image with the audio element on a computer-readable memory of the device such that, when the image is selected by at least one application of the device, the visual element and audio element are displayed with the image.

12. The method of claim 11, wherein the audio element is logically linked with altitude information.

13. The method of claim 11, wherein the audio elements is logically linked with time information.

14. The method of claim 11, wherein the audio elements is logically linked with one or more use cases.

15. The method of claim 14, wherein the one or more use cases are based an occurrence of an event.

16. The system of claim 14, wherein the one or more use cases is based on a non-occurrence of an event.

17. The method of claim 11, further comprising retrieving a social media group logically linked with a user of the device.

18. The method of claim 15, further comprising sending the audio element to the social media group.

19. The method of claim 11, wherein the audio element is manipulated using input from one or more sensors.

20. The method of claim 11, further comprising receiving a visual element associated with the geographic location identifier, and logically link the image with the visual element.
